(19) United States
(12) Patent Application Publication
(10) Pub. No.: US 2026/0347147 A1
(43) Pub. Date: Nov. 5, 2026

(54) Method and Control Unit for Carrying Out Service Work on a Passenger Transport System

(71) Applicant: INVENTIO AG, Hergiswil (CH)

(72) Inventor: Thomas Novacek, Schwechat (CH)

(21) Appl. No.: 19/483,588

(22) PCT Filed: Jul. 3, 2024
(86) PCT No.: PCT/EP2024/068739

§ 371 Date: Nov. 11, 2025

(30) Foreign Application Priority Data
Jul. 13, 2023 (EP) 23185230.2

(51) Int. Cl. B66B 5/00; B66B 25/00; G06T 7/00; G06T 7/13; G06T 7/246; G06T 11/00; G06V 10/774; G06V 20/20; G06V 20/52; H04N 7/18

(52) U.S. Cl. CPC B66B 5/0025; B66B 5/0087; B66B 25/006; G06T 7/0002; G06T 7/13; G06T 7/248; G06T 11/00; G06V 10/774; G06V 20/20; G06V 20/52; H04N 7/183; G06T 2207/30184

(57) ABSTRACT

A method for carrying out service work on a passenger transport system is proposed. The method comprises: receiving image data of a scene with a component of the passenger transport system; determining which component of the passenger transport system is concerned with the aid of a digital twin of the passenger transport system; determining at least one characteristic of the component with the aid of the twin data of the digital twin; generating a display signal for a visual display such that the characteristic of the component is displayed visually associated therewith; comparing the component represented by the image data with the digital representation of the component with the aid of the image data and the twin data; and determining whether the component should be replaced or not.

### CROSS-REFERENCE TO RELATED APPLICATIONS

This application is a national phase entry under 35 U.S.C. § 371 of the international patent application PCT/EP2024/068739 filed on Jul. 3, 2024 and published under the publication number WO 2025/012049A1, claiming priority right from the European patent application EP 23185230.2 filed on Jul. 13, 2023.

### FIELD OF THE INVENTION

The present invention relates to a method and to a control unit for carrying out service work on a passenger transport system configured as an elevator, escalator or a moving walkway.

### BACKGROUND OF THE INVENTION

Passenger transport systems of the aforementioned type are used to transport passengers or loads at or in buildings, for example between different levels or within a constant level. For example, escalators—also referred to as moving stairs—and elevators are used to transport passengers in a building from one floor to another floor. Moving walkways can be used to transport passengers within a floor in a horizontal plane or merely a slightly inclined plane.

Passenger transport systems usually have several assemblies, each of which is composed of individual components. When service work is being carried out on passenger transport systems, the assemblies, in particular the components, can be checked and replaced if necessary. For this purpose, the service personnel responsible require comprehensive knowledge of the relevant passenger transport system, in particular of the relevant assemblies and components, and of how the components are to be replaced and/or fitted. The technical complexity of such passenger transport systems can also lead to service personnel having to carry out work iteratively if the components responsible for a malfunction could not be clearly identified in advance. In particular, service personnel should know which components should be inspected after which period of operation of the passenger transport system, when and/or why the relevant components should be replaced, how to recognize that the relevant components should be replaced, and, in the event of replacement, how the relevant components should be replaced. This requires extensive training and, in some cases, years of experience before the service personnel are able to carry out the corresponding service work.

It is also known to adapt a passenger transport system during production to customer requirements and to the circumstances of the destination, which is also referred to as “commissioning.” For example, EP 3 724 118 B1 describes the commissioning of a passenger transport system with the help of a digital twin.

There may be a need, among other things, for a method for carrying out service work on a passenger transport system more simply and stringently, which method helps to ensure that the service work can be performed easily, precisely and/or with little learning effort by the service personnel applying the method.

A need of this kind can be met by the subject-matters according to the independent claims. Advantageous embodiments are explained both in the dependent claims and in the description below.

### SUMMARY OF THE INVENTION

According to a first aspect of the invention, a method for carrying out service work on a passenger transport system configured as an elevator, escalator or a moving walkway is described. The method comprises: receiving image data representative of an image showing a scene including a component of the passenger transport system; determining, with the aid of twin data of a digital twin of the passenger transport system, which component of the passenger transport system is shown in the scene, said twin data comprising a digital representation of the component; determining at least one characteristic of the component with the aid of the twin data; generating a display signal for a visual display such that the visual display, in response to receiving the display signal, visually displays the characteristic of the component such that when the scene is viewed using the visual display, the characteristic is recognizable as being assigned to the component; comparing the component represented by the image data with the digital representation of the component based on the image data and the twin data; determining, based on the comparison, whether the component should be replaced; generating a release signal indicating that the component should not be replaced if the comparison indicates that the component should not be replaced; and generating a replacement signal indicating that the component should be replaced if the comparison indicates that the component should be replaced.

According to a second aspect of the invention, a control unit for a service device for carrying out service work on the passenger transport system is described. The control unit comprises: a storage unit for storing the image data representative of the image showing the scene including the component of the passenger transport system, and the twin data of the digital twin of the passenger transport system is storable in the storage unit, said twin data comprising a digital representation of the component; and a processor communicatively coupled to the storage unit and configured to execute the method implemented in a program as described according to the first aspect of the invention. The program stored in the storage unit with the implemented method according to the first aspect of the invention can be retrieved by the processor for processing.

### DETAILED DESCRIPTION OF THE INVENTION

It should be noted that some of the possible features and advantages of the invention are described herein with reference to the different aspects and to different embodiments of the aspects. In particular, possible features and advantages of the invention are described partly with reference to embodiments of the method and partly with reference to embodiments of the control unit. A person skilled in the art will recognize that the features described for individual embodiments can be appropriately applied to other embodiments and/or other aspects, and that features can be appropriately combined, adapted, and/or exchanged to arrive at further embodiments of the invention.

The method can be executed, for example, by means of the control unit of the service device. Preferably, the method can be computer-implemented and/or carried out partially or fully automatically, for example with the aid of the control unit. In particular, the control unit can receive the image data, can determine which component of the passenger transport system is concerned, can determine the characteristic, can generate the display signal, the release signal and the replacement signal, can perform the comparison and can determine whether the component should be replaced. The service device can, for example, be augmented reality (AR) glasses, a cellphone, a tablet or a laptop of service personnel performing the service work. The image data can, for example, be generated by a camera that captures the scene, be sent to the control unit and be received by the control unit. The camera can, for example, be a camera of the service device and/or a CCD camera. The visual display can be a display of the service device.

The fact that the visual display visually displays the characteristic of the component such that the characteristic is assigned to the component means, for example, that the visual display displays the characteristic of the component superimposed on the component. The fact that the visual display visually displays the characteristic of the component such that the characteristic is assigned to the component when the scene is viewed means, in particular for all visual displays except for the AR glasses, that the scene is shown on the corresponding display and that, in addition, the characteristic is shown on the display such that it is assigned to the component, for example, superimposed on the component. In these cases, the display signal must therefore be generated such that it also contains image information about the scene. In contrast, in the case of AR glasses as a visual display, the lenses of the AR glasses correspond to the display of the AR glasses. In this case, the display is largely transparent, so that the scene can be viewed through the lenses of the AR glasses and does not have to be artificially displayed on the lenses. Accordingly, in the case of AR glasses as a visual display, the display signal does not need to contain information about the scene. The fact that the visual display visually displays the characteristic of the component such that the characteristic is assigned to the component when the scene is viewed means, in the case of AR glasses as a visual display, in particular that the service personnel view the real scene through the lenses of the AR glasses and that the characteristic is displayed on the lenses such that it is assigned to the component, for example, superimposed on the component. Such an overlay can, for example, be a red border around the component, a text field with an arrow pointing at the component, and the like.

The digital twin can also be called a digital double. The digital twin is represented by a corresponding digital data set, for example referred to as the twin data. The twin data can be stored in the storage unit and retrieved by the processor when needed. The digital twin, in particular the twin data, can be generated and stored, for example, as described in the prior art mentioned at the outset. Alternatively, other methods known from the prior art can be used to create the digital twin or the twin data. The digital twin, in particular the twin data, includes digital representations of target states of a plurality of components and assemblies of the passenger transport system and thus the properties of the components, wherein each assembly consists of two or more of the components. Ideally, the digital twin includes digital representations and thus the properties of all components of the passenger transport system, which are available digitally in the form of the twin data. The characteristic of the component can, for example, relate to an external shape of the component. For example, the external shape of the component can be specified by the at least one and/or possibly further properties of the component. For example, the external shape can be specified by one or more contours of the component, wherein the contours can be given as properties of the component and as part of the twin data.

Comparing the component represented by the image data with the digital representation of the component based on the twin data can, in particular, include detecting one or more differences between the corresponding real component and the digital representation of the component. The comparison of the component represented by the image data with the digital representation of the component based on the twin data is carried out automatically. This automatic comparison can be performed by means of a conventionally programmed algorithm. Alternatively, the automatic comparison can be performed by means of artificial intelligence and/or machine learning. For example, with the aid of a plurality of image data representing images with components and a plurality of digital representations of the components the AI can be trained to recognize the components with the aid of the image data and compare them with the corresponding digital representations. The training data, in particular the image data, for training the AI can be created, for example, by means of a program for creating the digital twin. In particular, a plurality of digital twins can be created in which one or more components are faulty and/or worn and need to be replaced. From these “faulty” or “worn” digital twins, in particular components, the image data showing the supposedly faulty and/or worn component(s) can then be generated to train the artificial intelligence, so that, after training, the artificial intelligence is able to recognize, with the aid of the received image data and the digital twin, whether the component(s) should be replaced or not.

According to one embodiment, when the component represented by the image data is compared with the digital representation of the component, a deviation of the component represented by the image data from the digital representation is determined, wherein it is determined that the component should be replaced if the deviation meets a specified condition, and wherein it is determined that the component should not be replaced if the deviation does not meet the specified condition. This makes it easy to determine whether the component should be replaced or not. For example, the deviation can be determined in the form of a distance and/or as a numerical value and the condition may be met if the distance or the numerical value is greater than a prespecified threshold value. The distance can basically be determined by means of any suitable mathematical distance function and/or metric.

According to one embodiment, the characteristic of the component that is determined with the aid of the twin data relates to a target state of the component, an actual state of the component is determined with the aid of the image data, and when the image represented by the image data is compared with the digital representation of the component, the actual state is compared with the target state. This can help to determine particularly precisely and/or reliably whether the component should be replaced or not.

According to one embodiment, the characteristic of the component relates to a contour of the component, and the display signal is generated such that the visual display, in response to receiving the display signal, displays the contour superimposed on the component. This can contribute to a particularly intuitive perception of the component by the service personnel.

According to one embodiment, the characteristic of the component may relate to current and/or stored operating data. The operating data are collected during operation of the passenger transport system and can be provided with a time stamp and stored in connection with the associated digital twin. At least one characteristic of the component can be determined from the operating data and saved as belonging to the component. Examples may include the operating data of a frequency converter or drive motor of the passenger transport system, whose visual appearance hardly changes over their service life and whose condition (efficiency) can be determined, for example, by recording power consumption and power output. The display signal is thus generated taking into account such operating data.

According to one embodiment, the method further comprises: generating a supply signal depending on the replacement signal if the comparison indicates that the component should be replaced, wherein the supply signal is representative of the component; and sending the supply signal to a supply device configured to retrieve the component from a warehouse and to provide it at a removal station. This makes it possible to automatically provide the service personnel with a new component that is to replace the component of the passenger transport system. The fact that the supply signal is generated depending on the replacement signal can, in the simplest case, mean that the replacement signal is used as the supply signal. This is possible if the supply device is able to correctly interpret the replacement signal. Otherwise, the supply signal can be generated depending on the replacement signal, wherein the supply signal is generated in a format that can be correctly interpreted by the supply device and that contains the same information content as the replacement signal, namely which component is concerned and whether the component should be replaced or not. The supply device can, for example, comprise a warehouse robot configured to automatically retrieve the component from the warehouse and to provide it at a removal station in response to receiving the supply signal.

According to one embodiment, if the comparison indicates that the component should be replaced, at least one assistance for replacing the component is determined, and the display signal is generated such that the determined assistance is displayed by means of the visual display. This can help to ensure that the service personnel will replace the component professionally and efficiently. Alternatively or additionally, the assistance can be provided acoustically, for example via a loudspeaker on the service device.

According to one embodiment, if the comparison indicates that the component should be replaced, the method further comprises: receiving replacement data representative of an actual replacement process in which the component is replaced; checking whether the actual replacement process corresponds to a prespecified replacement process associated with the component and based on the replacement data; and generating a first warning signal if the monitored replacement process deviates from the prespecified replacement process. In other words, the replacement process can be monitored in response to recognizing that the component should be replaced. The replacement process can be monitored, for example, by means of one or more sensors, for example optical sensors and/or the service device. For example, the actual replacement process can be recorded using the service device's camera. During such monitoring, these sensors generate the replacement data. The replacement data can then, for example, be sent to and received by the control unit. If the actual replacement process does not deviate from the prespecified replacement process, the first warning signal will not need to be generated. Optionally, in this case, a confirmation signal can be generated that is representative of the fact that the actual replacement process does not deviate from the prespecified replacement process. The replacement process can, for example, include one or more work steps that are necessary for replacing the component. Each of the work steps can comprise one or more actions of a robot, in particular of one or more actuators of the robot, and/or one or more manual actions to be performed by the service personnel.

According to one embodiment, if the component is replaced, the method further comprises: detecting at least one actual parameter value associated with the replacement of the component; checking whether the detected actual parameter value corresponds to a corresponding target parameter value; and generating a second warning signal if the detected actual parameter value does not correspond to the corresponding target parameter value. If the actual parameter value corresponds to the corresponding target parameter value, the second warning signal will not need to be generated. Optionally, in this case, a confirmation signal can be generated that is representative of the fact that the actual parameter value corresponds to the corresponding target parameter value. The actual parameter value can also be referred to as the actual value of a parameter. The parameter associated with replacing the component can, for example, be a physical value that is important in the replacement of the component. For example, the parameter can relate to a torque to be used for tightening a screw or nut used to fasten the component. Alternatively, the parameter can relate to an amount of fluid and/or lubricant to be introduced into the component or to be used in the assembly of the component. Optionally, two or more of the actual parameter values of one or more of the parameters can be determined and checked against corresponding target parameter values. Optionally, the actual parameter value can be saved in conjunction with the digital twin, regardless of whether the actual parameter value corresponds to the target parameter value or not. This makes it possible to subsequently determine the actual parameter value with the aid of the twin data, at least promptly after it has been saved.

According to one embodiment, the method further comprises: determining a remaining service life of the component depending on the comparison if the comparison indicates that the component should not be replaced; and generating the release signal such that the release signal is representative of the remaining service life. This makes it possible for the service personnel not only to be informed that the component should not be replaced at present, but also to be informed at the same time when the component is expected to be replaced, namely after the end of the determined remaining service life.

### BRIEF DESCRIPTION OF THE DRAWINGS

Embodiments of the invention will be described below with reference to the accompanying drawings, wherein neither the drawings nor the description are intended to be interpreted as limiting the invention.

FIG. 1 shows an example of an image showing a scene with a passenger transport system according to an embodiment of the present invention.

FIG. 2 shows a block diagram illustrating a function of a control unit for performing service work on the passenger transport system according to an embodiment of the present invention.

FIG. 3 shows a flowchart of an exemplary embodiment of a method for performing service work on the passenger transport system according to an embodiment of the present invention.

The drawings are merely schematic and are not to scale. In the various figures, identical reference signs denote identical or similar features.

### DETAILED DESCRIPTION OF THE DRAWINGS

FIG. 1 shows an example of an image 10 showing a scene 12 with a passenger transport system 14 according to an embodiment of the present invention. The passenger transport system 14 is suitable for transporting passengers between different height levels or within a constant height level, for example in buildings. The passenger transport system 14 can, for example, be an escalator, in particular moving stairs, an elevator system or a moving walkway. The passenger transport system 14 can consist of several assemblies, each of which is composed of several components, wherein in FIG. 1 one of the components, namely component 16, is highlighted for illustrative purposes. The component 16 can, for example, be a wearing part of the passenger transport system 14, for example a comb plate, a step roller, a step, a chain, in particular a drive chain, etc. The image 10 can be a three-dimensional image.

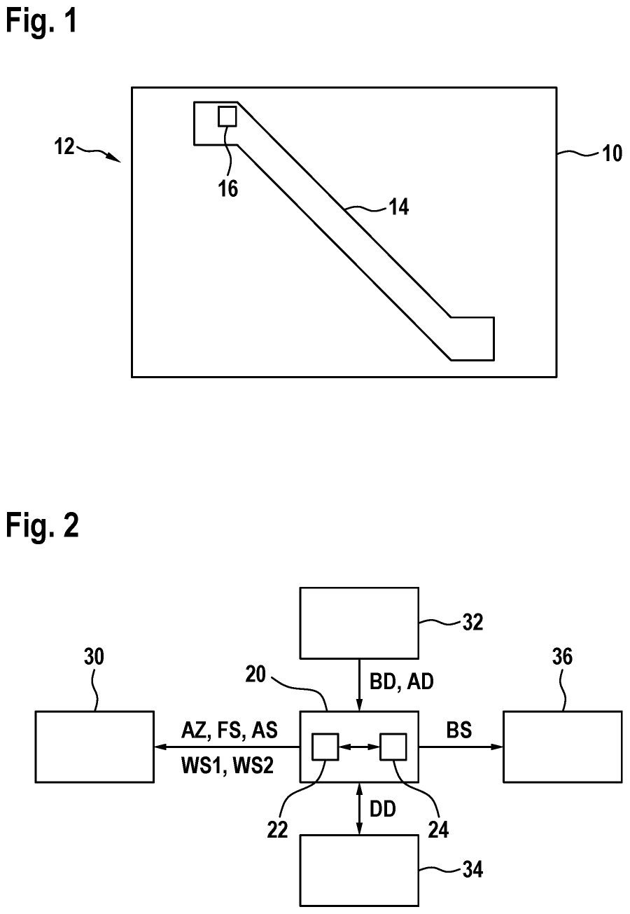

FIG. 2 shows a block diagram illustrating a function of a control unit 20 for performing service work on the passenger transport system 14 according to an embodiment of the present invention. The control unit 20 can, for example, be a component of a service device of service personnel (not shown) tasked with carrying out the service work. The service device can, for example, be augmented reality (AR) glasses, a cellphone, a tablet or a laptop of service personnel performing the service work.

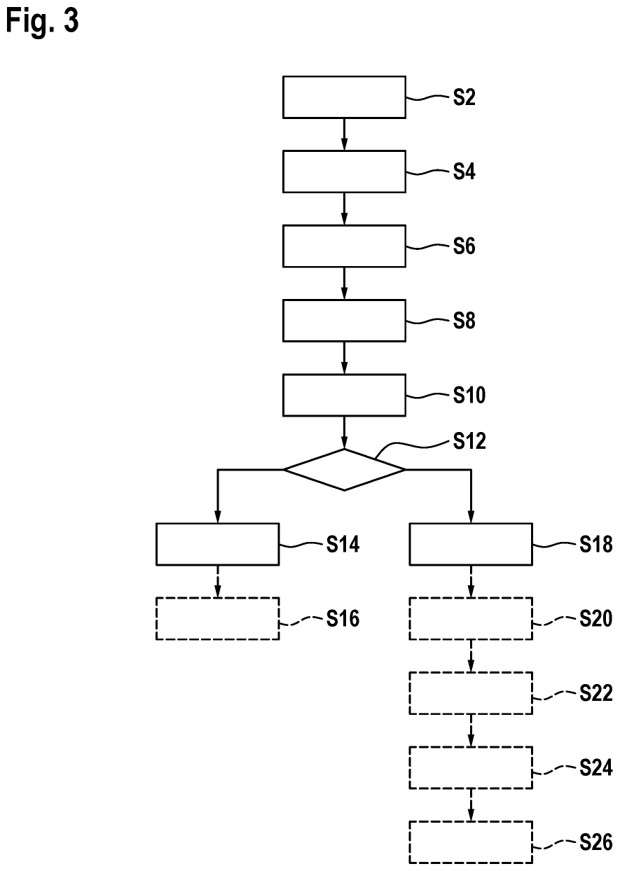

The control unit 20 has a storage unit 24 for storing image data BD representative of the image 10 showing the scene 12 with the component 16 of the passenger transport system 14, and twin data DD of a digital twin of the passenger transport system 14 including a digital representation of the component 16. The control unit 20 further comprises a processor 22 communicatively coupled to the storage unit 24 and configured to execute the method explained with reference to FIG. 3.

For this purpose, the control unit 20 communicates with a visual display 30, with one or more sensors 32, optionally with a database 34 and optionally with a supply device 36. The visual display 30, one or more of the sensors 32 and optionally the database 34 can be further components of the service device. The visual display 30 can, for example, be a display of the service device.

The control unit 20 is configured to generate a display signal AZ, a release signal FS, a replacement signal AS, optionally a first warning signal WS1, optionally a second warning signal WS2 and optionally a supply signal BS. The control unit 20 is configured in particular to send the display signal AZ to the visual display 30. Optionally, the control unit 20 can also send the release signal FS, the replacement signal AS and/or one or both of the warning signals WS1, WS2 to the visual display 30. Alternatively or additionally, the control unit 20 can be configured to send the release signal FS, the replacement signal AS and/or one or both of the warning signals WS1, WS2 to another display device, for example to another visual display (not shown) or to an acoustic display device (not shown).

The control unit 20 is further configured to receive image data BD, twin data DD of a digital twin and/or optionally replacement data AD relating to an actual replacement of the component 16. The image data BD and/or the replacement data AD can be generated, for example, by one or more of the sensors 32. The twin data DD can be stored in the database 34 and retrieved by the processor 22 when needed. Alternatively or additionally, the twin data DD can be stored in the storage unit 24. The twin data DD comprise extensive information about the passenger transport system 14, in particular on the assemblies and components of the passenger transport system 14, for example as described in the prior art EP 3 724 118 B1 cited at the outset. If the image 10 is a 3D image, the image data BD can include depth information in addition to the information required to control the pixels of the visual display 30. For example, the image data BD can include depth information for each pixel that is representative of how far an object shown in the pixel is away from the corresponding camera that captured the image 10.

The digital double can also be referred to as a digital twin. The digital twin is represented by a corresponding digital data set, in particular the twin data DD. The digital twin can be generated and stored, for example, as described in the prior art EP 3 724 118 B1 mentioned at the outset. Alternatively, other methods known from the prior art can be used to create the digital twin and thus the twin data DD. The digital twin includes digital representations of target states of a plurality of components 16 and assemblies of the passenger transport system, wherein each assembly consists of two or more of the components 16. Ideally, the digital twin includes digital representations of all components 16 of the passenger transport system 14. Furthermore, the twin data DD include properties of the components 16. The properties can, for example, relate to external shapes of the components 16. For example, the external shape of the component 16 can be prespecified by the at least one and/or possibly further properties of the component 16. For example, the external shape can be prespecified by one or more contours of the component 16, wherein the contours can be stored as properties of the component 16 and as part of the digital twin in the form of the twin data DD.

FIG. 3 shows a flowchart of an exemplary embodiment of a method for performing service work on the passenger transport system 14 according to an embodiment of the present invention. The method can be executed, for example, by means of the control unit 20.

In a step S2, the image data BD representative of the image 10 showing the scene 12 with the component 16 of the passenger transport system 14 can be received. The image data BD can be generated by means of the sensors 32 and received by the control unit 20. For this purpose, the sensors 32 can, for example, comprise a camera that captures the scene 12. The camera can, for example, be a camera of the service device and/or a CCD camera.

In a step S4, it can be determined, for example by means of the control unit 20, which component 16 of the passenger transport system 14 is concerned, in particular with the aid of the digital twin of the passenger transport system 14, which has a digital representation of the component 16, and/or in particular by means of a correspondingly trained AI.

In a step S6, at least one of the properties of the component 16 can be determined with the aid of the twin data DD, for example by means of the control unit 20. In particular, the characteristic can be stored as part of the twin data DD. The characteristic of the component 16, which is determined with the aid of the twin data DD, can, for example, relate to a target state of the component 16. An actual state of the component 16 can then be determined with the aid of the image data BD. As a result, when comparing the component 16 represented by the image data BD with the digital representation of the component 16, the actual state can be compared with the target state. In particular, the characteristic of the component 16 can, for example, relate to a contour of the component 16. In this case, the display signal AZ can be generated such that the visual display 30 displays the contour superimposed on the component 16 in response to receiving the display signal AZ.

In a step S8, the display signal AZ for the visual display 30 can be generated such that the visual display 30, in response to receiving the display signal AZ, visually displays the characteristic of the component 16 such that when the scene 12 is viewed by means of the visual display 30, the characteristic can be recognized as being assigned to the component 16. The fact that the visual display 30 visually represents the characteristic of the component 16 such that the characteristic is assigned to the component 16 means, for example, that the visual display 30 visually represents the characteristic of the component 16 such that the characteristic is superimposed on the component 16. The fact that the visual display 30 visually represents the characteristic of the component 16 such that the characteristic is assigned to the component 16 when the scene 12 is viewed means, in particular for all visual displays except for the AR glasses, that the scene 12 is shown on the corresponding display and that, in addition, the characteristic is shown on the display such that it is assigned to the component 16, for example, superimposed on the component 16.

In these cases, the display signal AZ must therefore be generated such that it also contains image information about the scene 12. The characteristic of the component 16 can, for example, be stored together with one, two or more further properties of the component 16, for example in the form of a component model data set of the component 16, wherein the component model data set can be part of the twin data DD.

In contrast, in the case of AR glasses as a visual display 30, the lenses of the AR glasses correspond to the display of the AR glasses. In this case, the display is largely transparent, so that the scene 12 can be viewed through the lenses of the AR glasses and does not have to be artificially displayed on the lenses. Accordingly, in the case of AR glasses as a visual display 30, the display signal AZ does not need to contain information about the scene 12. The fact that the visual display 30 visually represents the characteristic of the component 16 such that the characteristic is assigned to the component 16 when the scene 12 is viewed means, in the case of AR glasses as a visual display 30, in particular that the service personnel view the real scene through the lenses of the AR glasses and that the characteristic is displayed on the lenses such that it is assigned to the component 16, for example, superimposed on the component 16.

In a step S10, the component 16 represented by the image data BD can be compared with the digital representation of the component 16, in particular with the aid of the image data BD and with the aid of the digital twin, in particular with the aid of the twin data DD. Comparing the component 16 represented by the image data BD with the digital representation of the component 16 based on the digital twin data can, in particular, include detecting one or more differences between the corresponding real component 16 and the digital representation of the component 16. For example, when comparing the component 16 represented by the image data BD with the digital representation of the component 16, a deviation of the component 16 represented by the image data BD from the digital representation can be determined. In particular, it can be determined that the component 16 should be replaced if the deviation meets a specified condition, and that the component should not be replaced if the deviation does not meet the specified condition. For example, the deviation can be determined in the form of a distance and/or as a numerical value and the condition may be met if the distance or the numerical value is greater than a prespecified threshold value. The threshold value can also be referred to as a limit value, in particular as a dimension limit value. The distance can be basically determined by means of any suitable mathematical distance function and/or metric.

The comparison of the component 16 represented by the image data BD with the digital representation of the component 16 based on the twin data DD is carried out automatically. This automatic comparison can be performed using a conventionally programmed algorithm. Alternatively, the automatic comparison can be performed by means of artificial intelligence (AI) and/or machine learning. For example, the AI can be trained with the aid of a plurality of image data BD representing images 10 with components 16 and a plurality of digital representations of the components 16 to recognize the components 16 with the aid of the image data BD and compare them with the corresponding digital representations. The training data, in particular the image data BD, for training the corresponding AI can be created, for example, by means of a program for creating the digital twin. In particular, a plurality of digital twins can be created in which one or more components 16 are faulty and/or worn and need to be replaced. From these “faulty” or “worn” digital twins, in particular components 16, the image data BD showing the supposedly faulty and/or worn component(s) 16 can then be generated to train the artificial intelligence, so that, after training, the AI is able to recognize, with the aid of the received image data BD and the digital twin, whether the component(s) 16 should be replaced or not.

In a step S12, it can be determined whether the component 16 should be replaced or not, in particular depending on the comparison carried out in step S10. If the comparison indicates that the component 16 should not be replaced, the method can be continued in a step S14. If the comparison indicates that the component 16 should be replaced, the method can be continued in a step S18.

In step S14, the release signal FS can be generated. The release signal FS is representative of the fact that component 16 should not be replaced.

In an optional step S16, a remaining service life of the component 16 can be determined depending on the comparison. As a result, the release signal FS can be generated in such a way that the release signal FS is representative of the determined remaining service life of the component 16. The remaining service life of the component 16 can be determined, for example, by means of a look-up table in which properties of typical signs of wear and/or aging of the component are assigned corresponding remaining service lives. Such look-up tables can be determined in advance, for example empirically, and stored in the storage unit 24 and/or the database 34, optionally as part of the twin data DD. To determine the remaining service life, operating data stored in the twin data DD, in particular operating data provided with time information, can also be used.

In step S18, the replacement signal AS can be generated, which is representative of the fact that the component 16 should be replaced.

In an optional step S20, the supply signal BS can be generated depending on the replacement signal AS, wherein the supply signal BS is representative of the component 16 to be replaced. In addition, in step S20, the supply signal BS can be sent to a supply device (not shown) which is configured to obtain the component 16 from a warehouse and to provide it at a removal station (not shown). The fact that the supply signal BS is generated depending on the replacement signal AS can, in the simplest case, mean that the replacement signal AS is used as the supply signal BS. This is possible if the supply device 36 is able to correctly interpret the replacement signal AS. Otherwise, the supply signal BS can be generated depending on the replacement signal AS, wherein the supply signal BS is generated in a format that can be correctly interpreted by the supply device 36 and that contains the same information content as the replacement signal AS, namely which component 16 is concerned and that the component 16 should be replaced. The supply device 36 can, for example, comprise a warehouse robot configured to automatically retrieve the component 16 from the warehouse and to provide it at the removal station in response to receiving the supply signal BS.

Optionally, a maintenance date for replacing the component 16 with a corresponding supply of material can be scheduled in parallel with step S20, wherein the component 16 can then be provided at the removal station on the maintenance date, for example by means of the supply device 36.

In an optional step S22, at least one assistance for replacing the component 16 can be determined and the display signal AS can be generated such that the determined assistance is displayed by means of the visual display 30. Alternatively or additionally, the assistance can be provided acoustically, for example via a loudspeaker on the service device. If the component 16 has actually been replaced, one or more properties of the new component 16 can be saved as part of the twin data DD so that the digital twin is up to date.

In an optional step S24, in response to detecting that the component 16 should be replaced, a replacement process can be monitored in which the component 16 is replaced. In particular, the replacement process can be monitored in real time. The replacement process can, for example, include one or more work steps that are necessary for replacing the component 16. Each of the work steps can comprise one or more actions of a robot, in particular of one or more actuators of the robot, and/or one or more manual actions to be performed by the service personnel. Optionally, after the replacement of the component 16, the passenger transport system 14 and in particular the renewed component 16 can be checked, for example by re-capturing the passenger transport system 1, for example by means of the sensors 32, and by subsequently comparing the corresponding image(s) 10 with the digital twin based on the image data BD and the twin data DD, for example doing so by means of AI.

The replacement process can be monitored, for example, by means of one or more sensors 32, for example optical sensors and/or the service device. For example, the actual replacement process can be recorded by means of the service device's camera. During such monitoring, these sensors 32 generate the replacement data AD. The replacement data AD can then for example be sent to and received by the control unit 20. In step S24, the replacement data AD can thus be received which are representative of the actual replacement process in which the component 16 is actually replaced. The replacement data AD can include additional image data and/or video data.

Subsequently, the replacement data AD can be used to check whether the actual replacement process corresponds to a prespecified replacement process assigned to the component 16. Furthermore, a first warning signal WS1 can be generated if the monitored replacement process deviates from the prespecified replacement process. If the actual replacement process does not deviate from the prespecified replacement process, the first warning signal WS1 will not need to be generated. Optionally, in such case, a confirmation signal can be generated that is representative of the fact that the actual replacement process does not deviate from the prespecified replacement process.

In an optional step S26, at least one actual parameter value can be recorded which is associated with the replacement of the component 16. Furthermore, in step S26, it can be checked whether the recorded actual parameter value corresponds to a corresponding target parameter value. Furthermore, in step S26, a second warning signal WS2 can be generated if the detected actual parameter value does not correspond to the corresponding target parameter value. If the actual parameter value corresponds to the corresponding target parameter value, the second warning signal WS2 will not need to be generated. Optionally, in such case, a confirmation signal can be generated that is representative of the fact that the actual parameter value corresponds to the corresponding target parameter value.

The actual parameter value can also be referred to as the actual value of a parameter. The parameter associated with replacing the component 16 can, for example, be a physical value that is important in the replacement of the component 16. For example, the parameter can relate to a torque to be used to tighten a screw or nut used to fasten the component 16. Alternatively, the parameter can relate to an amount of fluid and/or lubricant to be introduced into the component 16 or to be used in the assembly of the component 16. Optionally, two or more of the actual parameter values of one or more of the parameters can be determined and checked against corresponding target parameter values. Optionally, the actual parameter value can be saved in conjunction with the digital twin, for example in the form of the twin data DD, regardless of whether the actual parameter value corresponds to the target parameter value or not. This makes it possible to subsequently determine the actual parameter value with the aid of the digital twin.

Optionally, an error analysis can then be carried out in order to optimize future service work. The error analysis can relate to processes that are too complicated for maintenance, or to errors in the procurement system or logistics system. During this error analysis, the AI, in other words the AI module, can suggest appropriate measures.

The aforementioned steps can be executed in a system comprising hardware and/or software, wherein at least one of the aforementioned service devices, in other words user devices, is available to the service personnel as hardware. The service device(s) and/or the components explained with reference to FIG. 2 can exchange data with one, two or more other platforms via known data interfaces, for example wired and/or wireless, for example with a central computer, with a computer network and/or the cloud.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above exemplary embodiments may also be used in combination with other features or steps of other exemplary embodiments described above. Reference signs in the claims should not be considered to be limiting.

List of reference signs

| | |
|---|---|
| 10 | Image |
| 12 | Scene |
| 14 | Passenger transport system |
| 16 | Component |
| 20 | Control unit |
| 22 | Processor |
| 24 | Storage unit |
| 30 | Visual display |
| 32 | Sensor |
| 34 | Database |
| 36 | Supply device |
| BD | Image data |
| DD | Twin data |
| AZ | Display signal |
| FS | Release signal |
| AS | Replacement signal |
| BS | Supply signal |
| AD | Replacement data |
| WS1 | First warning signal |
| WS2 | Second warning signal |
| S2-S26 | Steps two to twenty-six |

1. A method for carrying out service work on a passenger transport system which is designed as an elevator, escalator or a moving walkway, the method comprising:
receiving image data representative of an image showing a scene including a component of the passenger transport system;
determining, with the aid of twin data of a digital twin of the passenger transport system, which component of the passenger transport system is shown in the scene, said twin data comprising a digital representation of the component;
determining at least one characteristic of the component with the aid of the twin data;
generating a display signal for a visual display such that the visual display, in response to receiving the display signal, visually displays the characteristic of the component such that when the scene is viewed using the visual display, the characteristic is recognizable as being assigned to the component;
comparing the component represented by the image data with the digital representation of the component based on the image data and the twin data;
determining, based on the comparison, whether the component should be replaced;
generating a release signal indicating that the component should not be replaced if the comparison indicates that the component should not be replaced; and
generating a replacement signal indicating that the component should be replaced if the comparison indicates that the component should be replaced.

2. The method according to claim 1, wherein,
when the component represented by the image data is compared to the digital representation of the component, a deviation of the component represented by the image data from the digital representation is determined, wherein
it is determined that the component should be replaced if the deviation meets a prespecified condition, and
it is determined that the component should not be replaced if the deviation does not meet the prespecified condition.

3. The method according to claim 1, wherein
the characteristic of the component determined with the aid of the twin data is related to a target state of the component,
an actual state of the component is determined with the aid of the image data, and
when the image represented by the image data is compared to the digital representation of the component, the actual state is compared to the target state.

4. The method according to claim 1, wherein
the characteristic of the component relates to a contour of the component, and
the display signal is generated such that the visual display displays the contour superimposed on the component in response to receiving the display signal.

5. The method according to claim 1, wherein
the characteristic of the component relates to current operating data and/or stored operating data, and
the display signal is generated based on the operating data.

6. The method according to claim 1, further comprising:
generating a supply signal based on the replacement signal if the comparison indicates that the component should be replaced, wherein the supply signal is representative of the component; and
sending the supply signal to a supply device configured to retrieve the component from a warehouse and to provide it at a removal station.

7. The method according to claim 1, wherein, if the comparison indicates that the component should be replaced,
at least one piece of assistance for replacing the component is determined, and
the display signal is generated such that the determined piece of assistance is displayed by means of the visual display.

8. The method according to claim 1, further comprising, if the comparison indicates that the component should be replaced:
receiving replacement data representing an actual replacement process by which the component is replaced;
checking whether, based on the replacement data, the actual replacement process corresponds to a specified replacement process associated with the component; and
generating a first warning signal if the actual replacement process deviates from the prespecified replacement process.

9. The method according to claim 1, further comprising, if the component is replaced:
detecting at least one actual parameter value associated with the replacement of the component;
checking whether the detected actual parameter value corresponds to a corresponding target parameter value; and
generating a second warning signal if the detected actual parameter value does not correspond to the corresponding target parameter value.

10. The method according to claim 1, further comprising:
determining a remaining service life of the component based on the comparison if the comparison indicates that the component should not be replaced; and
generating the release signal representative of the remaining service life.

11. A control unit for a service device for carrying out service work on a passenger transport system which is designed as an elevator, escalator or a moving walkway, the control unit comprising:
a storage unit for storing image data representative of an image showing a scene including a component of the passenger transport system, herein
twin data of a digital twin of the passenger transport system is storable in the storage unit, said twin data comprising a digital representation of the component;
the control unit comprises a processor communicatively coupled to the storage unit and configured to execute the method according to claim 1 and implemented in a program; and
the program stored in the storage unit with the implemented method according to claim 1 is retrievable by the processor for processing.
